(19) United States
(12) Patent Application Publication
(10) Pub. No.: US 2011/0019814 A1
(43) Pub. Date: Jan. 27, 2011

(54) VARIABLE SIZED HASH OUTPUT GENERATION USING A SINGLE HASH AND MIXING FUNCTION

(76) Inventor: Joseph Roy Hasting, Orefield, PA (US)

Correspondence Address: GLOBAL IP SERVICES, PLLC, 10 CRESTWOOD LANE, NASHUA, NH, 03062, US

(21) Appl. No.: 12/507,078

(22) Filed: Jul. 22, 2009

(51) Int. Cl. H04L 9/28; H03M 13/09; G06F 11/10

(52) U.S. Cl. 380/28; 714/807; 714/E11.032

(57) ABSTRACT

A system and circuit for generating a variable sized hash output using a single hash and mixing function are disclosed. In one embodiment, a system for generating a variable sized hash output data includes a hash function module for generating an N bit hash result data by processing an M bit input data. The system also includes a mixing function module including a plurality of logic gates which implement a set of reversible arithmetic functions for generating an N bit hash output data by processing the N bit hash result data using the set of reversible arithmetic functions, where a subset of the N bit hash output data is used as the variable sized hash output data, and a size of the subset of the N bit hash output data is less than N bits.

### FIELD OF TECHNOLOGY

Embodiments of the present invention relate to the field of electronics. More particularly, embodiments of the present invention relate to encryption technology.

### BACKGROUND

Typically, a hash function is used to create hash values which are compressed representations of data elements of indeterminate size in a fixed sized system. For example, the hash function may be used to reduce address fields on IPv6 packet of 32 bytes size into one byte size. The one byte value can then be used in the fixed sized system to cache data or be used for flow control or prioritization. A good hash function should adhere to a uniform distribution requirement to have minimum collisions between the hash values, where a collision occurs when two or more inputs are directed to a single output. A hash function is said to have a uniform distribution when the hash values generated are evenly distributed among corresponding input vectors. For example, for a hash function of size “n” generated over a range of 2ⁿ input vectors, 2ⁿ different hash values need to be generated to meet the uniform distribution requirement.

Further, the good hash function should have a minimum funneling effect. The funneling effect occurs when the input vector values are coupled to hash values over a given range. For example, for a hash function of size n, the input vector values from “a” to “b” produces hash values “c” to “d” which are proportional to the input vector values. This may lead to oversubscription of buckets storing hash values.

A mixing function is used to improve performance of the hash function, i.e., to minimize collisions and to reduce the funneling effect. The mixing function scrambles bits of the hash values generated by the mixing function to generate a mixed result. Further, the mixing function may use a combinatorial logic to reduce the funneling effect by removing the coupling of the input vector values with the hash values. Furthermore, the mixing function should generate reversible mixed results such that the input of the mixing function can be determined by examining the mixed results.

The mixing function should also adhere to the uniform distribution requirement to have fewer or no collisions between the mixed results. The mixing function may adhere to the uniform distribution requirement when an entirety of mixed result is used as a final hash output. However, when a subset of the mixed result is to be used as a final hash output, the mixing function may not adhere to the uniform distribution requirement, which may result in more collisions than the case when the entirety of the mixed result is used as the final hash output.

### SUMMARY

A system and circuit for generating variable sized hash output using a single hash and mixing function are disclosed. In one aspect, a system for generating a variable sized hash output data includes a hash function module for generating an N bit hash result data by processing an M bit input data. The system also includes a mixing function module including a plurality of logic gates which implement a set of reversible arithmetic functions for generating an N bit hash output data by processing the N bit hash result data using the set of reversible arithmetic functions. For example, a subset of the N bit hash output data is used as the variable sized hash output data, and a size of the subset of the N bit hash output data is less than N bits.

In another aspect, a system for generating a variable sized hash output data includes first clocked flip-flop for processing an input string, and a hash function module coupled to the first clocked flip-flop for generating a hash result data based on the input string. The system further includes a mixing function module including a plurality of logic gates configured to implement a set of reversible arithmetic functions for generating a hash output data by processing the hash result data using a combination of the set of reversible arithmetic functions, where a subset of the hash output data is used as the variable sized hash output data.

The system also includes a second clocked flip-flop coupled between the hash function module and the mixing function module for forwarding the hash result data to the mixing function module. Further, the system includes a three-way multiplexer configured for processing a remainder of the input string when the hash function module is configured to process a portion of the input string per clock cycle.

In yet another aspect, a circuit for generating a variable sized CRC output data includes a first clocked flip-flop for processing a set of input data which includes an input string, an N bit CRC module coupled to the first flip-flop for generating a CRC result data based on the set of input data, and a second clocked flip-flop coupled to the N bit CRC module for forwarding the CRC result data. The circuit also includes a first mixing function module coupled to the second clocked flip-flop and including a first set of logic gates which implement a first set of reversible arithmetic functions for generating an interim CRC output data, and a third clocked flip-flop coupled to the first mixing function module for forwarding the interim CRC output data.

Further, the circuit includes a second mixing function module coupled to the third clocked flip-flop and including a second set of logic gates which implement a second set of reversible arithmetic functions for generating a CRC output data based on the interim CRC output data. Additionally, the circuit includes a fourth clocked flip-flop coupled to the second mixing function module for forwarding the CRC output data, where a subset of the CRC output data is used as the variable sized CRC output data.

Furthermore, the circuit includes a first multiplexer coupled to the N bit CRC module for selecting one of a seed parameter and the CRC result data based on the start input flag data. Moreover, the circuit includes a second multiplexer coupled to the first multiplexer for selecting one of a null value and an output of the first multiplexer which is fed to the N bit CRC module when a size of the input string is greater than a threshold size of the input string that can be handled by the first clocked flip-flop per clock cycle.

The systems and circuits disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates an exemplary system for generating a variable sized hash output data, according to one embodiment;

FIG. 2 illustrates a set of exemplary reversible arithmetic functions implemented in the mixing function module of FIG. 1, according to one embodiment;

FIG. 3 illustrates an exemplary table which illustrates a usage of the variable sized hash output data in FIG. 1, according to one embodiment;

FIG. 4 illustrates an exemplary system for generating a variable sized hash output data based on an input string of indeterminate size, according to one embodiment;

FIG. 5 illustrates an exemplary circuit for generating a variable sized CRC output data, according to one embodiment; and

FIG. 6 illustrates an exemplary timing diagram associated with the circuit of FIG. 5, according to one embodiment.

The drawings described herein are for illustration purposes only and are not intended to limit the scope of the present disclosure in any way.

### DETAILED DESCRIPTION

A system and circuit for generating variable sized hash output using a single hash and mixing function are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

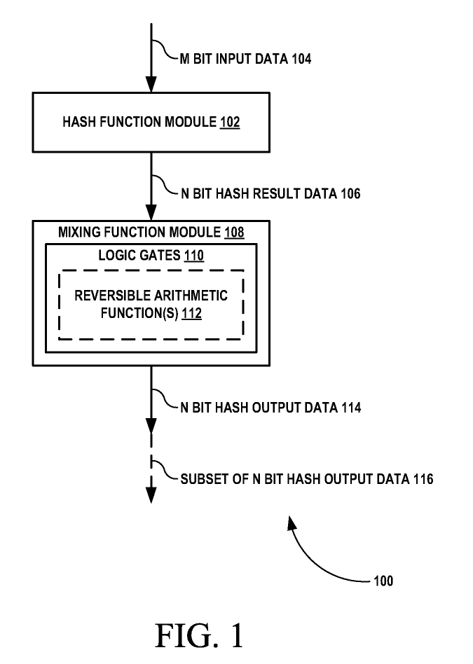

FIG. 1 illustrates an exemplary system 100 for generating a variable sized hash output data, according to one embodiment. As illustrated, the system 100 includes a hash function module 102 and a mixing function module 108. The mixing function 108 includes a plurality of logic gates 110 implementing a reversible arithmetic function(s) 112. The mixing function 108 is coupled to the hash function module 108 for generating the variable sized hash output data.

In operation, the hash function module 102 receives an M bit input data 104. Further, the hash function module 102 generates an N bit hash result data 106 by processing the M bit input data 104. It is appreciated that, the M bit input data 104 is greater than the N bit hash result data 106. The mixing function module 108 then processes the N bit hash result data 106 using a combination of reversible arithmetic function 112. The mixing function module 108 thus generates an N bit hash output data 114 by processing the N bit hash result data 106.

In one example embodiment, the reversible arithmetic function(s) 112 used generate the N bit hash output data 114 allows usage of a subset of N bit hash output data 116. For example, a size of the subset of N bit hash output data 116 is less than N bits. It can be noted that, the mixing function module 108 adheres to a uniform distribution requirement when the subset of N bit hash output data 116 is configured for use as the variable sized hash output data. In another example embodiment, the reversible arithmetic function(s) 112 is configured to reduce a funneling effect caused by the hash function module 102.

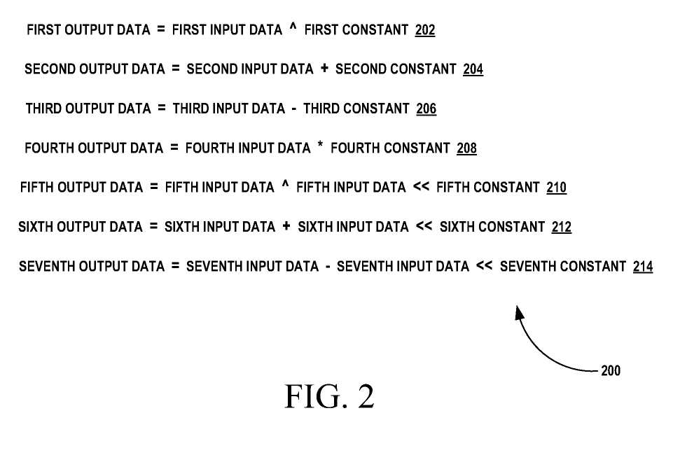

FIG. 2 illustrates a set of exemplary reversible arithmetic functions 200 implemented in the mixing function module 108 of FIG. 1, according to one embodiment. As described above, the set of reversible arithmetic functions 200 are implemented in the mixing function module 108 using the plurality of logic gates 110 for generating the hash output data 114. In particular, the set of reversible arithmetic functions 200 includes seven reversible arithmetic functions. The first reversible arithmetic function 202 includes a first output data=a first input datâa first constant. The first output data is computed by XORing the first input data and the first constant. The second reversible arithmetic function 204 includes a second output data=a second input data+a second constant. The second output data is computed by adding the second constant to the second input data.

The third reversible arithmetic function 206 includes a third output data=a third input data−a third constant. The third output data is computed by subtracting the third constant from the third input. The fourth reversible arithmetic function 208 includes a fourth output data=a fourth input data*a fourth constant. The fourth output data is computed by multiplying the fourth input data and the fourth constant. The fifth reversible arithmetic function 210 includes a fifth output data=a fifth input datâthe fifth input data<<a fifth constant. The fifth output data is computed by XORing the fifth input data and the fifth input data shifted left by the fifth constant.

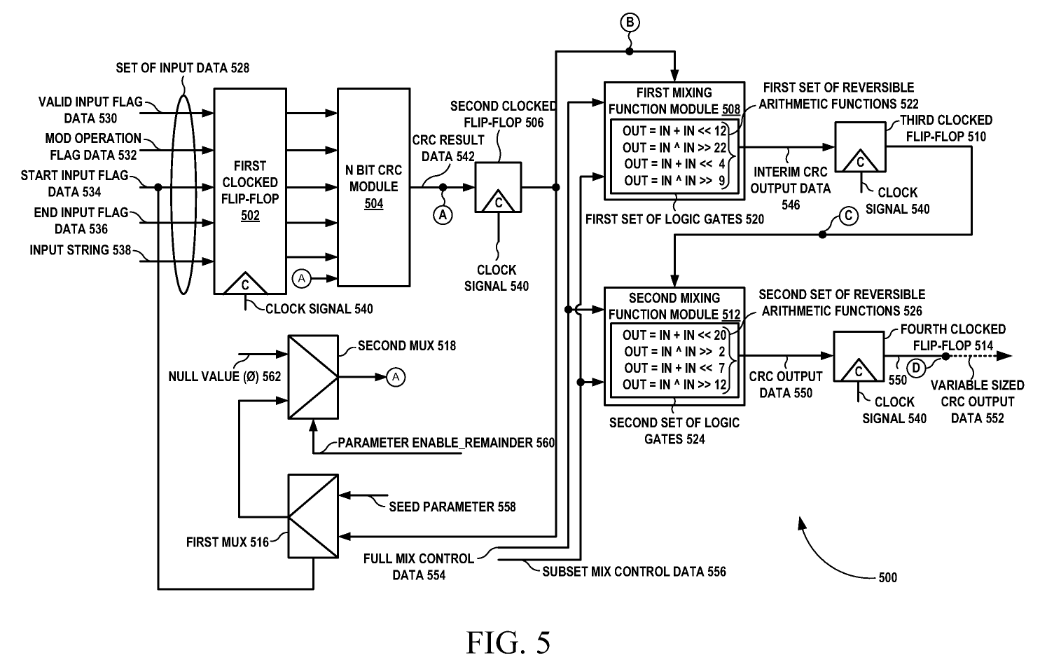

The sixth reversible arithmetic function 212 includes a sixth output data=a sixth input data+the sixth input data<<a sixth constant. The sixth output data is computed by adding the sixth input data and the sixth input data shifted left by the sixth constant. The seventh reversible arithmetic function 214 includes a seventh output data=a seventh input data−the seventh input data<<a seventh constant. The seventh output data is computed by subtracting the seventh input data shifted left by the seventh constant from the seventh input data. It is appreciated that, each input data is fed to a respective logic gate combination which implements one of the reversible arithmetic functions 202-214 to generate each output data, as will be illustrated in more detail in FIG. 5.

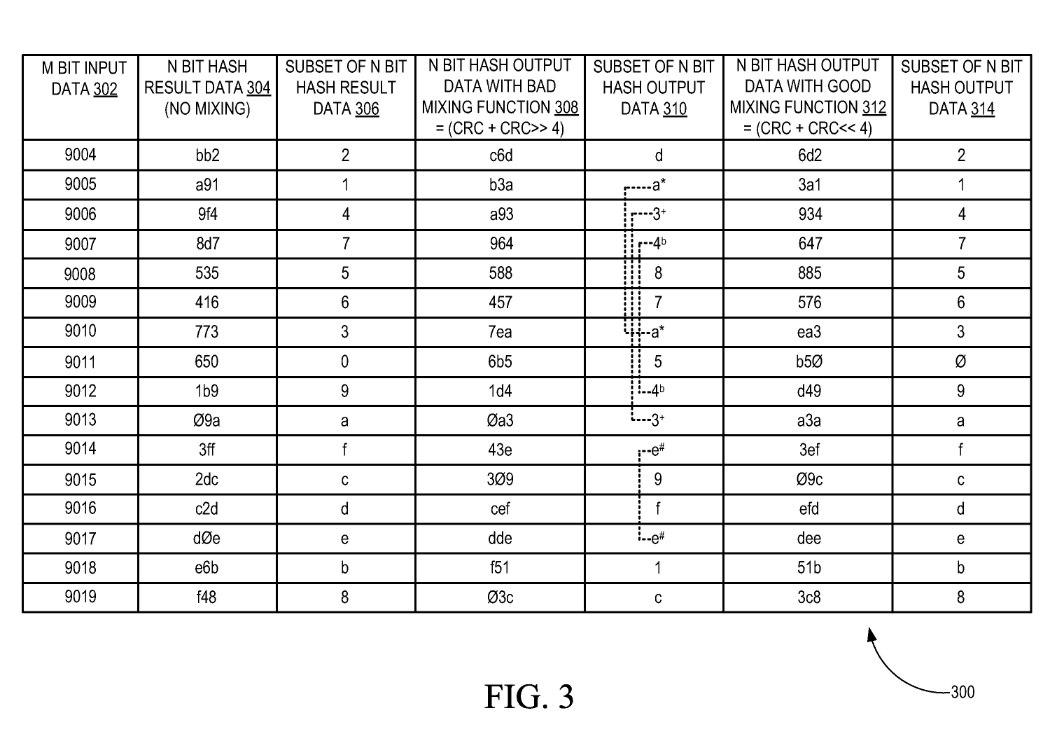

FIG. 3 illustrates an exemplary table 300 which illustrates a usage of the variable sized hash output data in FIG. 1, according to one embodiment. The table 300 includes M bit input data column 302, N bit hash result data column 304, a subset of N bit hash result data column 306, N bit hash output data with bad mixing function column 308, a subset of N bit hash output data column 310, N bit hash output data with good mixing function column 312 and a subset of N bit hash output data column 314.

The M bit input data column 302 shows sixteen different M bit input data values (e.g., 9004, 9005, 9006, etc.) which are received and processed by a hash function (e.g., the hash function module 102 of FIG. 1). The N bit hash result data column 304 shows N bit hash result data values (e.g., hexadecimal values) generated by the hash function by processing the M bit input data values. The subset of N bit hash result data column 306 shows a subset of the N bit hash result data values. In this example, the subset of N bit hash result data 306 is a 4 bit subset of binary values. For example, if the N bit hash result data 304 is ‘bb2’, then the subset of N bit hash result data 306 is ‘2’.

The N bit hash output data with bad mixing function column 308 shows N bit hash output data values generated using a bad mixing function by processing the values in the N bit hash result data column 304. For example, the bad mixing function may use an arithmetic function (e.g., N bit hash output data=CRC+CRC>>4), where the N bit hash output data is generated by adding the N bit hash result data 304 and the N bit hash result data 304 shifted right by 4. In this example, ‘c6d’ in the first row of the N bit hash output data column 308 is generated by adding ‘bb2’ and ‘bb2’ shifted right by 4. The subset of N bit hash output data column 310 shows a subset of N bit hash output data values. For example, if the N bit hash output data is ‘c6d’, then the subset of N bit hash output data is ‘d’.

The N bit hash output data with good mixing function column 312 shows N bit hash output data values generated using a good mixing function. For example, the good mixing function may use an arithmetic function (e.g., N bit hash output data=CRC+CRC<<4), where the N bit hash output data is generated by adding the N bit hash result data 304 and the N bit hash result data 304 shifted left by 4. In this example, ‘6d2’ in the first row of the N bit hash output data column 312 is generated by adding ‘bb2’ and ‘bb2’ shifted left by 4. The subset of N bit hash output data column 314 shows subset of the N bit hash output data values generated by the good mixing function. For example, if the N bit hash output data is ‘6d2’, then the subset of N bit hash output data is ‘2’.

From the above table 300, it can be seen that, the N-bit hash output data generated by the bad mixing function does not adhere to the uniform distribution requirement since the subset values of the N bit hash output data are having more collisions than the subset of N bit hash result data 306. The uniform distribution requires sixteen unique N bit hash output data values over sixteen N bit hash result data values for a 4 bit hash. For example, a subset ‘a’ in second row is colliding with a subset ‘a’ in seventh row of the subset of N bit hash output data column 310.

Similarly, a subset ‘4’ in fourth row is colliding with a subset ‘4’ in ninth row of the subset of N bit hash output data column 310. As a result, the N bit hash output data generated by the bad mixing function may not allow a subset of the N bit hash output data to be used as the variable sized hash output data. Whereas, the N bit hash output data generated by the good mixing function, which uses a reversible arithmetic function, allows a subset of the N bit hash output data to be used as the variable sized hash output data as the good mixing function adheres to a uniform distribution requirement.

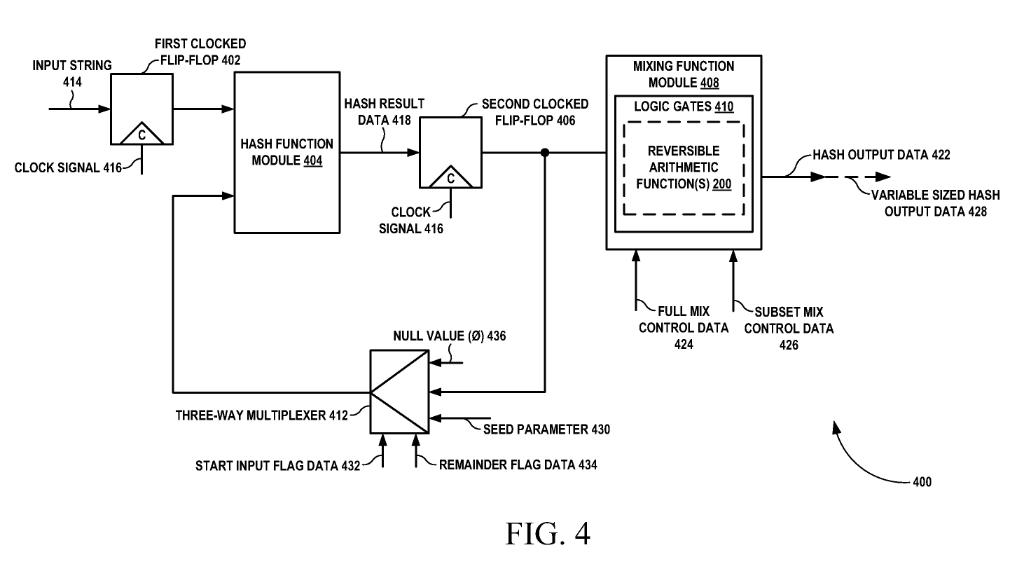

FIG. 4 illustrates an exemplary system 400 for generating a variable sized hash output data 428 based on an input string of indeterminate size 414, according to one embodiment. As illustrated, the system 400 includes a first clocked flip-flop 402, a hash function module 404, a second clocked flip-flop 406, and a mixing function module 408. As illustrated, the mixing function module 408 includes logic gates 410. In one exemplary implementation, the logic gates 410 are configured to implement the set of reversible arithmetic functions 200 of FIG. 2. Additionally, the system 400 includes a three-way multiplexer 412. As illustrated, the hash function module 404 is coupled to the first clocked flip-flop 402. The second clocked flip-flop 406 is coupled between the hash function module 404 and the mixing function module 408.

In operation, the first clocked flip-flop 402 receives an input string 414 and processes the input string 414. The first clocked flip-flop 402 then forwards the processed input string 414 to the hash function module 404 based on a clock signal 416. For example, the first clocked flip-flop 402 forwards the input string 414 when the clock signal 416 goes high. Further, the hash function module 404 generates hash result data 418 based on the input string 414. The hash function module 404 then forwards the hash result data 418 to the second clocked flip-flop 406 which forwards it to the mixing function module 408. The second clocked flip-flop 406 forwards the hash result data 418 based on the clock signal 416.

The mixing function module 408 generates a hash output data 422 by processing the hash result data 418 using a combination of the reversible arithmetic functions 200 of FIG. 2. In one embodiment, the mixing function module 408 generates the hash output data 422, which is of the same size as the hash result data 418, when a full mix control data 424 is enabled. In this embodiment, an entirety of the hash output data 422 is used as the variable sized hash output data 428. It can be noted that, the mixing function module 408 uses all the reversible arithmetic functions 200 when an entirety of the hash output data 422 is configured for use.

In another embodiment, the mixing function module 408 generates a subset of the hash output data 422, which his of smaller size than the hash result data 418, when a subset mix control data 426 is enabled. In this embodiment, the subset of the hash output data 422 is used as the variable sized hash output data 428. It can be noted that, the mixing function module 408 may use a subset of the reversible arithmetic functions 200 when the subset of the hash output data 422 is configured for use.

In yet another embodiment, the mixing function module 408 outputs the hash result data 418 as the hash output data 422 when both the full mix control data 424 and the subset mix control data 426 are disabled. It can be noted that, the system 400 performs the above-described operation (e.g., paragraphs 34-36) when the size of the input string 414 is less than or equal to the threshold size of the input string 414, where the threshold size of the input string 414 may be the size of the input string 414 that the first clocked flip-flop 402 can process per clock cycle. It is appreciated that in such a case, the remainder flag data 434 remains off and the three-way multiplexer selects a null value 436 to be fed to the hash function module 404.

If the size of the input string 414 is greater than the threshold size of the input string 414, then the system 400 operates in the manner described below. In operation, the first clocked flip-flop 402 forwards a portion of the input string 414 (e.g., a start of the input string 414) to the hash function module 404. The first clocked flip-flop 402 then forwards the portion of the input string 414 based on the clock signal 416. Also, the three-way multiplexer 412 feeds a seed parameter 430 to the hash function module 404. In one example embodiment, the three-way multiplexer 412 selects the seed parameter 430 as output when both start input flag data 432 and remainder flag data 434 are on. It is appreciated that the start input flag data 432 is on if the input string 414 fed to the hash function module 404 is a start portion of the input string 414, where the size of the entire input string 414 is larger than the threshold size. It is also appreciated that the remainder flag data 434 is on as long as there remains a portion of the input string 414 yet to be processed.

Subsequently, the hash function module 404 generates the hash result data 418 which is partial in nature by processing the portion of the input string 414 and the seed parameter 430. Further, the hash function module 404 forwards the hash result data 418 to the second clocked flip-flop 406. The second clocked flip-flop 406 then forwards the hash result data 418 which corresponds to the start of the input string 414 to the mixing function module 408. The mixing function module 408 thus processes the hash result data 418 and generates the hash output data 422. The hash output data 422 in this case in invalid and is not used as the variable sized hash output data 424 as the input string 414 is not yet fully processed by the hash function module 404.

Further, the second clocked flip-flop 406 also inputs the hash result data 418 to the three-way multiplexer 412. The three-way multiplexer 412 then feeds the hash result data 416 to the hash function module 404. In one embodiment, the three-way multiplexer 412 selects the hash result data 418 as output when the start input flag data 430 is off and the remainder flag data 434 is on. The remainder flag data 434 is on when a remaining portion of the input string 414 is yet to be processed by the hash function module 404. In one example embodiment, the three-way multiplexer 412 is configured to process a remainder of the input string 414 when the hash function module 404 is configured to process a portion of the input string 414 per clock cycle.

Also, the first clocked flip-flop 402 forwards the remaining portion of the input string 414 to the hash function module 404 based on the clock signal 416 (e.g., at a subsequent clock cycle). In one example embodiment, a size of the remaining portion of the input string 414 is less than or equal to the threshold size of the input string 414. The hash function module 404 generates the hash result data 418 which is complete by processing the remaining portion of the input string 414 and the hash result data 418, which was formed from the previous clock cycle and partial in nature, fed by the three-way multiplexer 412. The hash function module 404 then forwards the hash result data 418, which is complete and valid, to the second clocked flip-flop 406. It is appreciated that the three-way multiplexer 412 feeds the null value 436 to the hash function module 404 when the remainder flag data 434 is off indicating the fully completed process of the input string 414 by the hash function module 404.

Also, the second clocked flip-flop 406 forwards the hash result data 418 to the mixing function module 408 based on the clock signal 420. The mixing function module 408 then generates a valid one of the hash output data 422 by processing the hash result data 418. It can be noted that, the mixing function module 408 generates the valid one of the hash output data 422 when the remainder of the input string 414 is fully processed by the hash function module 404. In one embodiment, the mixing function module 408 generates the valid one of the hash output data 422 when a full mix control data 424 is enabled. In this embodiment, an entirety of the hash output data 422 is used as the variable sized hash output data 428. Further, the mixing function module 408 uses all the reversible arithmetic functions 200 when the entirety of the hash output data 422 is configured for use.

In another embodiment, the mixing function module 408 generates a subset of the hash output data 422 when the subset mix control data 426 is enabled. In this embodiment, the subset of the hash output data 422 is used as the variable sized hash output data 428. It can be noted that, the mixing function module 408 uses a subset of the reversible arithmetic functions 200 when the subset of the hash output data 422 is configured for use. In yet another embodiment, the mixing function module 408 outputs the hash result data 418 as the hash output data 422 when both the full mix control data 424 and the subset mix control data 426 are disabled.

FIG. 5 illustrates an exemplary circuit 500 for generating a variable sized CRC output data, according to one embodiment. As illustrated, the circuit 500 includes a first clocked flip-flop 502 (e.g., a clocked D type flip-flop), an N bit cyclic redundancy check (CRC) module 504, a second clocked flip-flop 506 (e.g., a clocked D type flip-flop), a first mixing function module 508, a third clocked flip-flop 510 (e.g., a clocked D type flip-flop), a second mixing function module 512, and a fourth clocked flip-flop 514 (e.g., a clocked D type flip-flop). In addition, the circuit 500 includes a first multiplexer (mux) 516 and a second multiplexer (mux) 518.

As shown in FIG. 5, the N bit CRC module 504 is coupled to the first clocked flip-flop 502. The second clocked flip-flop 506 is coupled to the N bit CRC module 504. The first mixing function module 508 is coupled to the second clocked flip-flop 506. The third clocked flip-flop 510 is coupled to the first mixing function module 508 and the second mixing function module 512 is coupled to the third clocked flip-flop 510. Moreover, the fourth clocked flip-flop 514 is coupled to the second mixing function module 512. Further, the first mux 516 is coupled to the N bit CRC module 504 and the second mux 518 is coupled to the first mux 516.

Also, As illustrated, the first mixing function module 508 includes a first set of logic gates 520 which implements a first set of reversible arithmetic functions 522. Similarly, the second mixing function module 512 includes a second set of logic gates 524 which implements a second set of reversible arithmetic functions 526.

In operation, the first clocked flip-flop 502 receives a set of input data 528. The set of input data 528 may include a valid input flag data 530, a modulo (MOD) operation flag data 532, a start input flag data 534, an end input flag data 536, and an input string 538. For example, the valid input flag data 530 may indicated a valid input data. The MOD operation flag data 532 indicates number of invalid bytes per clock cycle. The start input flag data 534 indicates a start of the input string 538 and the end input flag data 536 indicates end of the input string 538.

Further, the first clocked flip-flop 502 processes the set of input data 528 and forwards the processed set of input data 528 to the N bit CRC module 504 based on a clock signal 540. The N bit CRC module 504 generates a CRC result data 542 based on the set of input data 528. The N bit CRC module 504 then forwards the CRC result data 542 to the second clocked flip-flop 506 which then forwards it to the first mixing function module 508. The second clocked flip-flop 506 forwards the CRC result data 542 based on the clock signal 540.

The first mixing function module 508 generates an interim CRC output data 546 by processing the CRC result data 542 using a combination of the first set of reversible arithmetic functions 522. For example, the first set of reversible arithmetic functions 522 may include out=in+in<<12, out=in̂in>>22, out=in+in<<4, and out=in̂in>>9. It is appreciated that, “in” and “out” represent input to and output of a respective logic gate combination of the first set of logic gates 520, respectively. Further, the first mixing function module 508 forwards the interim CRC output data 546 to the third clocked flip-flop 510 which then forwards it to the second mixing function module 512 based on the clock signal 540.

The second mixing function module 512 generates a CRC output data 550 by processing the interim CRC output data 546 using a combination of the second set of reversible arithmetic functions 526. For example, the second set of reversible arithmetic functions 526 may include out=in+in<<20, out=in̂in>>2, out=in+in<<7, and out=in̂in>>12. It is appreciated that, “in” and “out” represent input to and output of a respective logic gate combination of the second set of logic gates 524, respectively. The second mixing function module 512 then forwards the CRC output data 550 to the fourth clocked flip-flop 514 such that the CRC output data 550 may be used as a variable sized CRC output data 552.

In one exemplary implementation, the variable sized CRC output data 552 may be generated based on a full mix control data 554 and a subset mix control data 556. In one embodiment, the full mix control data 554 is enabled when a whole of the CRC output data 550 is configured for use. Thus, when the full mix control data 554 is enabled, the first mixing function module 508 generates the interim CRC output data 546 using out=in+in<<12, out=in̂in>>22, out=in+in<<4, and out=in̂in>>9. For example, the first mixing function module 508 may perform out=in+in<<12, where the input “in” to out=in+in<<12 is the CRC result data 542. Further, the output “out” of out=in+in<<12 is used as an input “in” for out=in+in<<22. Thus, an output “out” of one reversible arithmetic function is used as an input “in” for a subsequent reversible arithmetic function of the first set of reversible arithmetic functions 522. Finally, an output “out” is generated by performing out=in̂in>>9, which is then used as the interim CRC output data 546.

Further, the second mixing function module 512 may generate the CRC output data 550 by processing the interim CRC output data 546 using out=in+in<<20, out=in̂in>>2, out=in+in<<7, and out=in̂in>>12. For example, the second mixing function module 512 may perform out=in+in<<20, where the input “in” to the out=in+in<<20 is the interim CRC output data 546. Further, the output “out” of out=in+in<<20 is used as an input “in” to out=in+in<<2. Thus, an output “out” of one reversible arithmetic equation is used as an input “in” for a subsequent reversible arithmetic function of the second set of reversible arithmetic functions 524. Finally, an output “out” is generated by performing out=in̂in>>12, which is then used as the CRC output data 550. In this case, the whole of the CRC output data 550 is used.

In another embodiment, the subset mix control data 556 is enabled when a subset of the CRC output data 550 is configured for use. In one example embodiment when the subset mix control data 556 is enabled, the first mixing function module 508 generates the interim CRC output data 546 using out=in+in<<12 and out=in+in<<4. For example, the first mixing function module 508 may perform out=in+in<<12, where the input “in” to out=in+in<<12 is the CRC result data 542. Further, the output “out” of out=in+in<<12 is used as an input “in” for out=in+in<<4. The output “out” of out=in+in<<4 is used as the interim CRC output data 546.

Further, the second mixing function module 512 may generate the CRC output data 550 by processing the interim CRC output data 546 using out=in+in<<20, and out=in+in<<7. For example, the second mixing function module 512 may perform out=in+in<<20, where the input “in” to out=in+in<<20 is the interim CRC output data 546. Further, the output “out” of out=in+in<<20 is used as an input “in” to out=in+in<<7. The output “out” of out=in+in<<7 is then used as the CRC output data 550. Thus, a subset of the CRC output data 550 can be used as the variable sized CRC output data 552.

In yet another embodiment, both the full mix control data 554 and the subset mix control data 556 are disabled when the CRC result data 542 is configured for use. It is appreciated that the operation of the circuit 500 described in paragraphs 48-56 is performed when the size of the input string 538 is less than or equal to the threshold size of the input string 538, where the threshold size of the input string 538 may be the size of the input string 538 that the first clocked flip-flop 502 can process per clock cycle. It is appreciated that in such a case, the parameter enable_remainder 560 remains off and the second mux 518 selects a null value 562 to be fed to the N bit CRC module 504.

If the size of the input string 538 (e.g., 160 bits) is greater than the threshold size (e.g., 64 bits) of the input string 538, then the circuit 500 operates in the manner described below. In operation, upon triggering of the first clock cycle, the first clocked flip-flop 502 forwards a portion of the input string 538 (e.g., a start portion of the input string 538 which is the first 64 bits) to the N bit CRC module 504 based on the clock signal 540. Also, the first mux 516 feeds a seed parameter 558 to the second mux 518 based on the start input flag data 534 (e.g., where the seed parameter 558 is selected only when the start input flag data 534 is on). The second mux 516 then feeds the seed parameter 558 to the N bit CRC module 504 based on a parameter enable_remainder 560 (e.g., when parameter enable_remainder 560 is on which indicates that the input string 538 being processed is larger than the threshold size that can be handled by the first clock flip-flop 502 per clock cycle). The N bit CRC module 504 generates the CRC result data 542 which is partial in nature by processing the portion of input string 538 and the seed parameter 558. The N bit CRC module 504 also forwards the CRC result data 542 to the second clocked flip-flop 506.

Upon triggering of the second clock cycle, the second clocked flip-flop 506 then forwards the CRC result data 542 to the first mux 516. The first mux 516 then selects the CRC result data 542 based on the start input flag data 534 (e.g., which is off). As a result, the first mux 516 forwards the CRC result data 542 to the second mux 518. The second mux 518 selects the CRC result data 542 as the output based on the parameter enable_remainder 560 (e.g., when the parameter enable_remainder is on) and feeds the CRC result data 542 to the N bit CRC module 504. At the same time, the first clocked flip-flop 502 forwards the second 64 bits of the 160 bit input string 538 to the N bit CRC module 504 to generate the hash result data 542, which is the partial hash result data based on the 128 bits of the 160 bit input string 538.

Upon triggering of the third clock cycle, the second clocked flip-flop 506 then forwards the CRC result data 542 to the first mux 516. The first mux 516 then selects the CRC result data 542 based on the start input flag data 534 (e.g., which is off). As a result, the first mux 516 forwards the CRC result data 542 to the second mux 518. The second mux 518 selects the CRC result data 542 as the output based on the parameter enable_remainder 560 (e.g., when the parameter enable_remainder is on) and feeds the CRC result data 542 to the N bit CRC module 504. At the same time, the first clocked flip-flop 502 forwards the remaining 32 bits of the 160 bit input string 538 to the N bit CRC module 504 to generate the hash result data 542, which is the complete or full hash result data. It is appreciated that the second mux 518 feeds the null value 562 to the N bit CRC module 504 when the parameter enable_remainder 560 is off indicating the fully completed process of the input string 538 by the N bit CTC module 504.

Accordingly, the N bit CRC function module 504 generates the CRC result data 542 which is complete and forwards to the second clocked flip-flop 506. The second clocked flip-flop 506 forwards the complete CRC result data 542 to the first mixing function module 508 to generate an interim CRC output data 546. The interim CRC output data 546 thus generated is fed to the third clocked flip-flop 510 which is then forwarded to the second mixing function module 512 based on the clock signal 540. The second mixing function module 512 then generates the CRC output data 550 by processing the interim CRC result data 546.

Further, the CRC output data 550 is forwarded to the fourth clocked flip-flop 514 to generate the variable sized CRC output data 552 based on the clock signal 540. It can be noted that, the variable sized CRC output data 552 may be a subset of the CRC output data 550 or a whole of the CRC output data 550 generated based on a configuration of the subset mix control data 556 and the full mix control data 554 respectively. In one exemplary implementation, the variable sized CRC output data 552 is generated using the first mixing function module 512 and the second mixing function module in the similar manner as described in paragraphs 50-56.

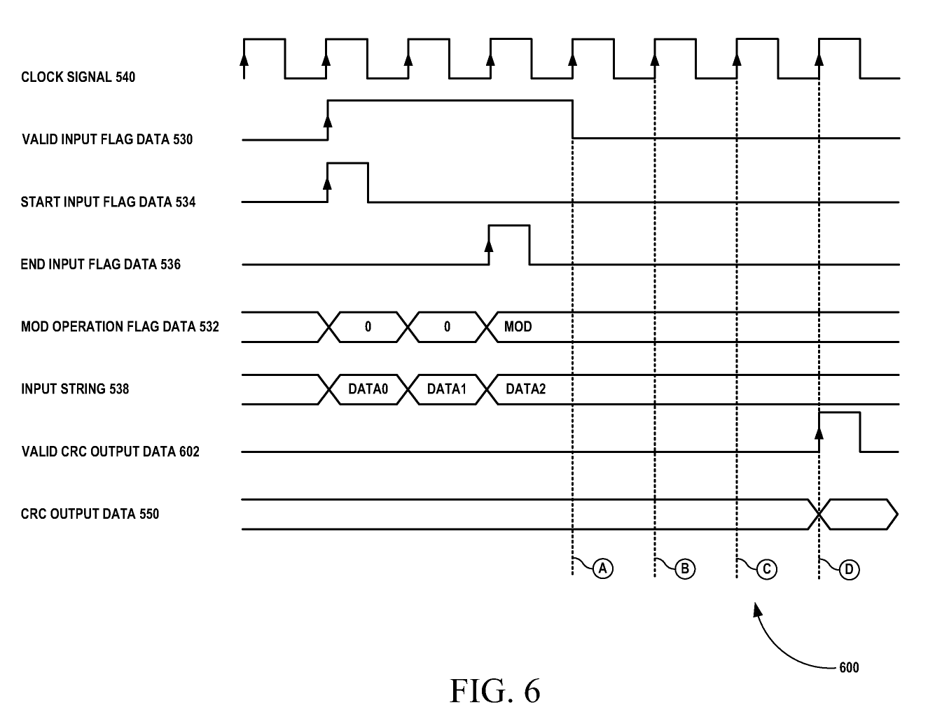

FIG. 6 illustrates an exemplary timing diagram 600 associated with the circuit 500 of FIG. 5, according to one embodiment. As illustrated, the clock signal 540 periodically cycles at a clock rate. The valid input data 530 indicates that the input string 538 is valid for 3 cycles. The start input flag data 534 indicates the start of the input string 538. The end input flag data 536 indicates the end of the input string 538. The MOD operation flag data 532 indicates the size of invalid input string 538 per clock cycle. The input string 538 indicates input data that is processed by the N bit CRC module 504 to generate the CRC result data 542.

As discussed in FIG. 5, the valid input data 530, the start input flag data 534, the end input flag data 536, the MOD operation flag data 532, and the input string 538 constitutes the set of input data 528. It can be noted that the valid input data 530, the start input flag data 534, the end input flag data 536, the MOD operation flag data 532 and the input string 538 are processed based on the same clock signal 540.

As illustrated in FIG. 5, the first clocked flip-flop 502 provides 64 bits to the N bit CRC module 504 per clock cycle. The N bit CRC module 504 thus processes 64 bits of the input string 538 to generate the CRC result data 542 which is partial in nature. Further, the N bit CRC module 504 outputs the CRC result data 542 which is complete by processing 160 bits of the input string 538 in three clock cycles (e.g., 64 bits/cycle) as indicated by the mark “A.” The CRC result data 542 is then forwarded to the second clocked flip-flop 506 which then forwards the complete CRC result data 542 to the first mixing function module 508 at a subsequent clock cycle, as indicated by the mark “B.”

Further, the first mixing function module 508 generates the interim CRC output data 546 and forwards it to the third clocked flip-flop 510. The third clocked flip-flop 510 forwards the interim CRC output data 546 to the second mixing function module 512 at a subsequent clock cycle, as indicated by the mark “C.” The second mixing function module 512 then generates the CRC output data 550 and forwards it to the fourth clocked flip-flop 514. Lastly, the fourth clocked flip-flop 514 outputs the CRC output data 550 at a subsequent clock cycle, as indicated by the mark “D.” As illustrated, a valid CRC output data 602 indicates that the CRC output data 550 is valid for use.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuit (ASIC)).

What is claimed is:

1. A system for generating a variable sized hash output data, comprising:
a hash function module for generating an N bit hash result data by processing an M bit input data; and
a mixing function module comprising a plurality of logic gates which implement a set of reversible arithmetic functions for generating an N bit hash output data by processing the N bit hash result data using the set of reversible arithmetic functions, wherein a subset of the N bit hash output data is used as the variable sized hash output data, and wherein a size of the subset of the N bit hash output data is less than N bits.

2. The system of claim 1, wherein the set of reversible arithmetic functions comprises a first output data=a first input datâa first constant (exclusive OR the first input data and the first constant), a second output data=a second input data+a second constant (add the second constant to the second input data), a third output data=a third input data−a third constant (subtract the third constant from the third input), a fourth output data=a fourth input data*a fourth constant (multiply the fourth input data and the fourth constant), a fifth output data=a fifth input datâthe fifth input data<<a fifth constant (exclusive OR the fifth input data and the fifth input data shifted left by the fifth constant), a sixth output data=a sixth input data+the sixth input data<<a sixth constant (add the sixth input data and the sixth input data shifted left by the sixth constant), and a seventh output data=a seventh input data−the seventh input data<<a seventh constant (subtract the seventh input data shifted left by the seventh constant from the seventh input data), and wherein each input data is fed to a respective logic gate combination which implements one of the set of reversible arithmetic functions to generate each output data.

3. The system of claim 1, wherein the set of reversible arithmetic functions is configured to reduce a funneling effect caused by the hash function module.

4. A system for generating a variable sized hash output data, comprising:
a first clocked flip-flop for processing an input string;
a hash function module coupled to the first clocked flip-flop for generating a hash result data based on the input string;
a mixing function module comprising a plurality of logic gates configured to implement a set of reversible arithmetic functions for generating a hash output data by processing the hash result data using a combination of the set of reversible arithmetic functions; and
a second clocked flip-flop coupled between the hash function module and the mixing function module for forwarding the hash result data to the mixing function module, wherein a subset of the hash output data is used as the variable sized hash output data.

5. The system of claim 4, wherein the set of reversible arithmetic functions comprises a first output data=a first input datâa first constant (exclusive OR the first input data and the first constant), a second output data=a second input data+a second constant (add the second constant to the second input data), a third output data=a third input data−a third constant (subtract the third constant from the third input), a fourth output data=a fourth input data*a fourth constant (multiply the fourth input data and the fourth constant), a fifth output data=a fifth input datâthe fifth input data<<a fifth constant (exclusive OR the fifth input data and the fifth input data shifted left by the fifth constant), a sixth output data=a sixth input data+the sixth input data<<a sixth constant (add the sixth input data and the sixth input data shifted left by the sixth constant), and a seventh output data=a seventh input data−the seventh input data<<a seventh constant (subtract the seventh input data shifted left by the seventh constant from the seventh input data).

6. The system of claim 4, further comprising a three-way multiplexer configured for processing a remainder of the input string when the hash function module is configured to process a portion of the input string per clock cycle.

7. The system of claim 6, wherein the mixing function module is configured to generate a valid one of the hash output data when the remainder of the input string is fully processed by the hash function module.

8. The system of claim 6, wherein the three-way multiplexer is configured to process one of: a null value; a seed parameter; and the hash result data.

9. The system of claim 8, wherein the seed parameter is fed to the hash function module when the portion of the input string is from a start of the input string.

10. The system of claim 8, wherein the hash result data is fed to the hash function module when the portion of the input string is not from the start of the input string.

11. The system of claim 4, wherein the combination of the set of reversible arithmetic functions comprises all of the set of reversible arithmetic functions when an entirety of the hash output data is used as the variable sized hash output data.

12. The system of claim 4, wherein the combination of the set of reversible arithmetic functions comprises a subset of the set of the reversible arithmetic functions when a subset of the hash output data is used as the variable sized hash output data.

13. A circuit for generating a variable sized CRC output data, comprising:
a first clocked flip-flop for processing a set of input data which includes an input string;
an N bit CRC module coupled to the first flip-flop for generating a CRC result data based on the set of input data;
a second clocked flip-flop coupled to the N bit CRC module for forwarding the CRC result data;
a first mixing function module coupled to the second clocked flip-flop and comprising a first set of logic gates which implement a first set of reversible arithmetic functions for generating an interim CRC output data;
a third clocked flip-flop coupled to the first mixing function module for forwarding the interim CRC output data;
a second mixing function module coupled to the third clocked flip-flop and comprising a second set of logic gates which implement a second set of reversible arithmetic functions for generating a CRC output data based on the interim CRC output data; and
a fourth clocked flip-flop coupled to the second mixing function module for forwarding the CRC output data, wherein a subset of the CRC output data is used as the variable sized CRC output data.

14. The circuit of claim 13, wherein the set of input data further comprise a valid input flag data, a modulo (MOD) operation flag data, a start input flag data, and an end input flag data associated with the input string.

15. The circuit of claim 14, further comprising a first multiplexer coupled to the N bit CRC module for selecting one of a seed parameter and the CRC result data based on the start input flag data.

16. The circuit of claim 15, further comprising a second multiplexer coupled to the first multiplexer for selecting one of a null value and an output of the first multiplexer which is fed to the N bit CRC module when a size of the input string is greater than a threshold size of the input string that can be handled by the first clocked flip-flop per clock cycle.

17. The circuit of claim 13, wherein the first set of arithmetic functions comprises (a) out=in+in<<12, (b) out=in̂in>>22, (c) out=in+in<<4, and (d) out=in̂in>>9, wherein “in” and “out” represent input to and output of a respective arithmetic function, respectively.

18. The circuit of claim 17, wherein the second set of arithmetic functions comprises (e) out=in+in<<20, (f) out=in̂in>>2, (g) out=in+in<<7, and (h) out=in̂in>>12, wherein “in” and “out” represent input to and output of a respective arithmetic function, respectively.

19. The circuit of claim 18, wherein steps (a), (c), (e), and (g) are performed when a subset of the CRC output data is configured for use.

20. The circuit of claim 18, wherein steps (a) through (h) are performed when a whole of the CRC output data is configured for use.
